(19) United States
(12) Patent Application Publication
(10) Pub. No.: US 2013/0033369 A1
(43) Pub. Date: Feb. 7, 2013

(54) ELECTRONIC ANTI-THEFT APPARATUS AND SYSTEM FOR VEHICLES

(71) Applicant: Ronald A. Burnett, Seville, OH (US)

(72) Inventor: Ronald A. Burnett, Seville, OH (US)

(21) Appl. No.: 13/196,246

(22) Filed: Aug. 2, 2011

(51) Int. Cl. B60R 25/10

(52) U.S. Cl. 340/426.11

(57) ABSTRACT

An electronic anti-theft system and method is described herein. The system may inhibit the completion of vehicle theft, carjacking, as well as deter any unauthorized use of the vehicle. The system may include an input device and a microcontroller. The input device may communicate with an engine control module of a motor vehicle, wherein the engine control module controls an engine of the motor vehicle. The microcontroller may communicate with a door sensor of the vehicle and be able to detect when a door is opened. The microcontroller may include a door open circuit that can send a signal to the engine control module to disable the engine after a predetermined amount of time has lapsed in response to detecting that the door was opened. The microcontroller may disable the engine provided that a PIN is not received at the input device within the predetermined amount of time.

### FIELD OF THE INVENTION

The present invention generally relates to a vehicle security system and, more particularly, to an electronic anti-theft apparatus for preventing vehicle theft.

### BACKGROUND

Vehicle theft is often a problem in today's society. These thefts may result in a large cost to the owner and/or operator to replace a stolen vehicle not to mention any increased insurance costs. A number of vehicle security systems have been utilized in order to prevent such as loss.

Theft of motor vehicles may require the thief to “hotwire” the vehicle before driving away. If the thief is unable to hotwire the motor vehicle or does not know how to hotwire the vehicle, the thief may resort to carjacking. Carjacking may be defined as the taking of a motor vehicle from the owner and/or operator by force, violence, or intimidation. In many carjackings weapons, such as knives or handheld firearms, may be used to coerce the owner to leave the vehicle.

Carjackings may most frequently occur while the owner is driving the vehicle and is temporarily stopped, such as at a traffic light or stop sign. Carjackings, however, may also occur at other times, such as before the owner enters the vehicle. Once the thief gets the owner's keys, the vehicle may easily be taken. This type of scenario may often occur at a gas station or in a parking lot. Violent personal confrontations during a carjacking may leave the owner feeling helpless, frightened and violated. These confrontations may also leave the owner physically injured.

Vehicle theft prevention devices may be utilized to prevent unauthorized access to and operation of a vehicle. Many typical theft prevention devices, however, are ineffective and have inherent drawbacks that may make them inefficient. Essentially, alarm systems do not work anymore. There is always an alarm going off somewhere, often by mistake, and unfortunately almost no one pays attention to the alarm. For example, often times these alarms may be activated by someone innocently bumping the car next to them in a parking lot.

Other devices may include wheel locking devices. These wheel locking devices, however, may easily be removed by sawing or using Freon to break them off of the steering column. While these types of devices may provide a visible warning, they are really only effective after the vehicle is already parked and locked and not effective at all for carjacking situations when the vehicle owner is present. Situations where the vehicle owner is present are of most concern because this is when injury or loss of life may occur.

Alternatively, vehicle tracking systems may be used to locate the stolen or carjacked vehicle. These types of tracking devices, however, can make no guarantees as to what type of condition the vehicle will be in if or when it is eventually located. Most often the vehicle may already be stripped of parts or damaged in other ways when the vehicle is located and retrieved.

### SUMMARY

An electronic anti-theft system is described herein. The electronic anti-theft system may include an input device and a microcontroller. The input device may be adapted to communicate with an engine control module of a motor vehicle, wherein the engine control module may be capable of controlling an engine of the motor vehicle. The microcontroller may be located within the input device, wherein the microcontroller may be adapted to communicate with the engine control module.

The microcontroller may be adapted to communicate with a door sensor of the vehicle, wherein the microcontroller may be capable of detecting when a door is opened, such as the driver's side door. The microcontroller may also include a door open circuit that may be capable of sending a signal to the engine control module to disable the engine after a predetermined amount of time has lapsed in response to detecting that the door was opened. The microcontroller may also be operative to disable the engine provided that a predetermined input, such as a PIN, is not received at the input device within the predetermined amount of time, such as within approximately thirty seconds.

A method of operating an electronic anti-theft system is also described. The method may include the step of engaging an input device with an engine control module of a motor vehicle. The input device may include a microcontroller capable of detecting when an engine of the motor vehicle has been started. The method may also include the step of receiving a predetermined input, such as a PIN, into the input device within a predetermined amount of time, such as thirty seconds, thereby activating an engine run circuit. The method may detect the opening of a driver's side door after receiving the PIN, thereby activating a door open circuit. The method may also include the steps of failing to receive the re-entry of the PIN within the predetermined amount of time, thereby activating an engine disrupt circuit, and disabling the engine for a specified amount of time by way of the engine disrupt circuit.

### BRIEF DESCRIPTION OF THE DRAWINGS

Objects and advantages together with the operation of the invention may be better understood by reference to the following detailed description taken in connection with the following illustrations, wherein:

FIG. 1 illustrates a side view of an electronic anti-theft system for a vehicle.

FIG. 2 illustrates a partial perspective view of the electronic anti-theft system of FIG. 1.

FIG. 3 illustrates a top perspective view of an input device of an electronic anti-theft system.

FIG. 4 illustrates a partially exploded bottom perspective view of the input device of FIG. 3.

FIG. 5 illustrates a circuit schematic of the electronic anti-theft system.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention. Additionally, as used herein, the term “exemplary” is intended to mean serving as an illustration or example of something, and is not intended to indicate a preference.

An electronic anti-theft system 10 (the “system 10”) is illustrated in FIG. 1. The electronic anti-theft system 10 may be of any appropriate shape, size, type or configuration. The system 10 may be utilized for any appropriate purpose. For example, the electronic anti-theft system 10 may be utilized to prevent any unauthorized use of a motor vehicle 12.

The electronic anti-theft system 10 may inhibit the completion of vehicle theft, carjacking, as well as deter any unauthorized use of the vehicle 12. The system 10 may enhance the safety of the owner/operator in carjacking situations as well as increase the recoverability of the vehicle 12. The system 10 may also be affordable, relatively simple to operate and may be used on any motor vehicle 12 that has an electronic ignition system 20.

The electronic anti-theft system 10 may be installed as an aftermarket accessory. The system 10 may go in any type of motor vehicle 12 that has an electronic ignition system 20, such as a car, truck, motorcycle, boat and the like. The system 10 works regardless of whether the operator has a key or not.

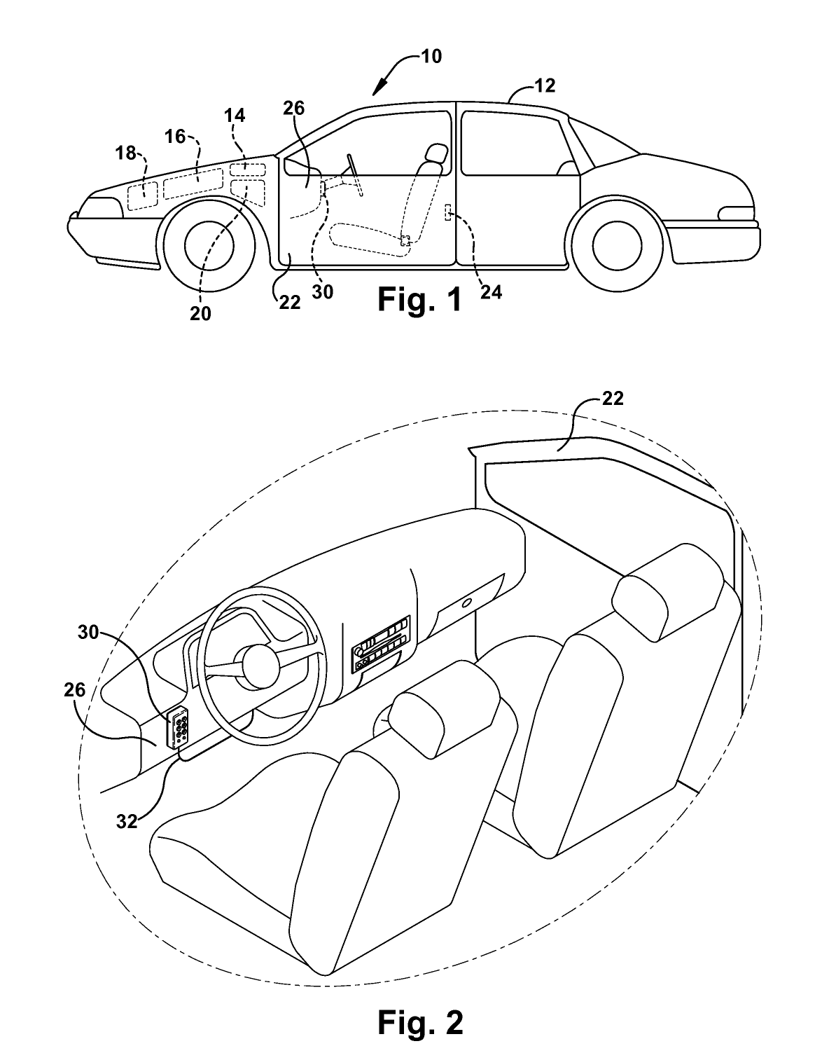

With reference to FIGS. 2-4, the electronic anti-theft system 10 may be operated by a small hand-held unit, such as an input device 30. The electronic anti-theft system 10 may also include a circuit board 60, at least one button and at least one light. The input device 30 may be of any appropriate shape, size, type or configuration, whereby information may be entered into the device 30 via a keypad, buttons, fingerprint, card swipe, scanner, voice command, and the like. In an exemplary embodiment, the input device 30 may be a keypad device.

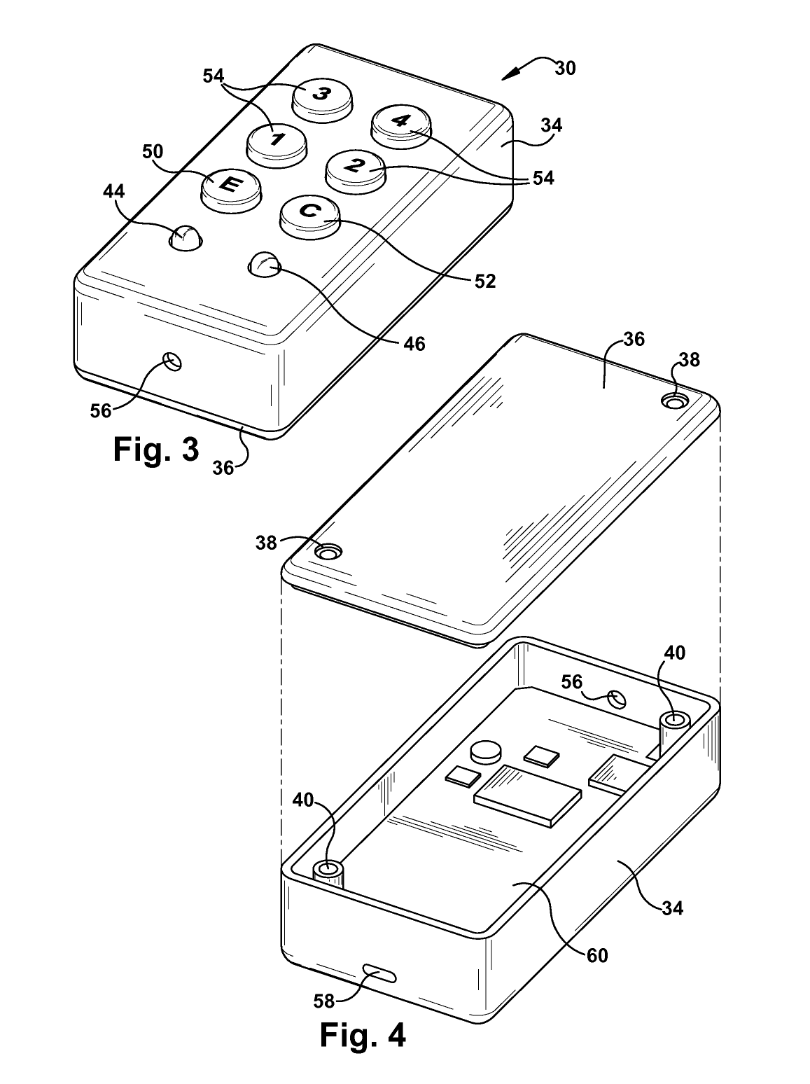

As illustrated in FIGS. 3 and 4, the input device 30 may be of a generally hollow square or rectangular configuration, whereby the input device 30 may include an upper housing 34 and a lower housing 36. The upper housing 34 may be of any appropriate shape, size, type or configuration, such as of a generally square or rectangular shape. For example, the upper housing 34 may include walls extending approximately perpendicularly outward from the upper housing 34 to create a hollow opening. The upper housing 34 may be located at any appropriate position on the apparatus 10, such as located above the lower housing 36.

The lower housing 36 may be of any appropriate shape, size, type or configuration, such as of a generally square or rectangular shape. For example, the lower housing 36 may be of a similar shape and size as that of the upper housing 34.

With reference to FIG. 4, the upper housing 34 and lower housing 36 may each include at least one mounting aperture, such as a plurality of mounting apertures 38. For example, the upper housing 34 and lower housing 36 may each include a similar number of mounting apertures 38, such as approximately four mounting apertures 38 each. The mounting apertures 38 may be of any appropriate shape, size, type or configuration, such as a generally circular shape. For example, the mounting apertures 38 may be located at an approximate corner location on the upper housing 34 and lower housing 36, such that the mounting apertures 38 may be generally aligned with one another, such that any appropriate number and type of fasteners (not shown) may be utilized to secure the upper housing 34 to the lower housing 36.

The upper housing 34 and lower housing 36 may each include at least one post 40. The posts 40 may be of any appropriate shape, size, type or configuration, such as of a generally cylindrical post 40. The posts 40 may be located at any appropriate position on the upper housing 34 and lower housing 36, such as adjacent the corners of the upper housing 34 and lower housing 36. The posts 40 may aid in the assembly of the upper housing 34 and lower housing 36 together.

The upper housing 34 may include any appropriate number of lighting apertures (not shown). For example, the upper housing 34 may include approximately two lighting apertures. The lighting apertures may be located at any appropriate position on the upper housing 34, such as located towards a first end of the upper housing 34.

The input device 30 may include any appropriate number of lighting features. For example, as shown in FIG. 3, the input device 30 may include approximately two lighting features 44, 46. The lighting features may be of any appropriate shape, size, type or configuration, such as light-emitting diodes (LEDs) 44, 46. The LEDs 44, 46 may be of any appropriate color, whereby one may be a Green LED 44 and the other may be an Amber LED 46.

The input device 30 may include any appropriate number of button apertures (not shown). For example, the upper housing 34 may include approximately six button apertures. The button apertures may be located at any appropriate position on the upper housing 34, such as located towards a second and opposite end of the upper housing 34 away from the lighting apertures.

The input device 30 may include any appropriate number of buttons, such as a plurality of buttons 50, 52, 54. For example, in a non-limiting example, the electronic anti-theft apparatus 10 may include six buttons 50, 52, 54.

The buttons 50, 52, 54 may be of any appropriate shape, size, type or configuration, such as of a generally square, circular, triangular shape or the like. For example, as shown in FIG. 3, the buttons 50, 52, 54 may be of a push button configuration.

The buttons 50, 52, 54 may be utilized to control the electronic anti-theft system 10. For example, two of the buttons 50, 52 may be programming mode buttons, whereby they may control the functions of the system 10, such as an “ENTER” button 50 and a “CLEAR” button 52. In addition, four of the buttons may be numeric digits buttons 54, whereby they may correspond to numbers, such as 1, 2, 3 and 4.

The input device 30 may include an output aperture 56. The output aperture 56 may be of any appropriate shape, size, type or configuration, such as a generally square or rectangular shape. With reference to FIGS. 3 and 4, the output aperture 56 may be located at any appropriate position on the input device 30 such as at a first end of the input device 30.

The input device 30 may be secured or mounted in any appropriate manner to an interior of the vehicle 12. With reference to FIGS. 1 and 2, in an exemplary embodiment, the input device 30 may be removably mounted onto a dashboard 26 of the vehicle 12 in any appropriate manner, such as by Velcro. Alternatively, the input device 30 may be placed within a cup holder or MP3 holder.

The system 10 may engage an engine control module 14 of the vehicle in any appropriate manner. Referring to FIG. 2, the apparatus 10 may be operatively connected to the vehicle by any appropriate means, such as by way of a cable 32. For example, the cable 32 may be engaged with the circuit board 60 of the input device 30. That cable 32 may then be routed through an electrical rubber boot that runs beneath a steering column of the vehicle 12, such as where the electrical harness may be located. The cable 32 may then run through the rubber boot through to the engine compartment of the vehicle 12 where the cable 32 may engage the systems of the vehicle 12. For example, the system 10 may be powered by the battery 18 of the vehicle 12.

The cable 32 may be of any appropriate shape, size, type or configuration. In an exemplary embodiment, the cable 32 may be a six pin connector, whereby the wires may be soldered onto the circuit board 60. The other end of the cable 32 may be connected to the vehicle circuits (not shown), such as the battery circuits, engine circuits, and vehicle courtesy light circuit, by way of a fuse box (not shown).

For example, the fuse box may be located at any appropriate position in the vehicle 12, such as where an ignition circuit and a door ajar circuit may be located. The fuse box may include a fuse that may provide power to the engine control module 14 of the vehicle 12. In an exemplary embodiment, a microcontroller 62 on the circuit board 60 may control the fuse that provides power to the engine control module 14.

The input device 30 may include a switch 58. The switch 58 may be of any appropriate shape, size, type or configuration, such as of a generally circular or rectangular shape. With reference to FIG. 4, the switch 58 may be located at any appropriate position on the input device 30, such as located on a side of the input device 30. The switch 58 may toggle or be selectable between two positions.

As an alternative, the system 10 may also include a pressure sensor (not shown). The pressure sensor may be of any appropriate shape, size, type or configuration. The pressure sensor may be located at any appropriate position, such as under the driver's side seat.

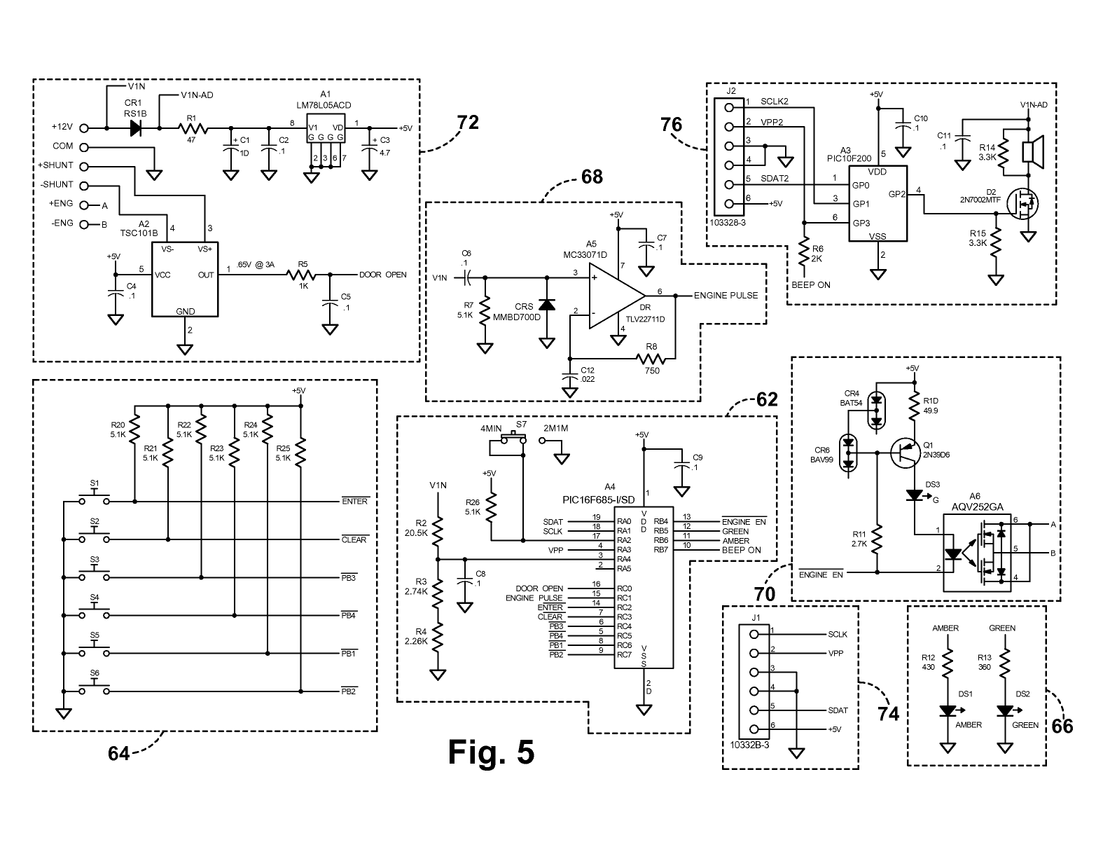

The circuit board 60 of the electronic anti-theft system 10 may be of any appropriate shape, size, type or configuration, such as a generally rectangular or square shaped printed circuit board 60. With reference to FIG. 4, the circuit board 60 may be located within the input device 30. The circuit board 60 may include any appropriate type or number of components and mechanisms to control the electronic anti-theft system 10. For example, as illustrated in FIG. 5, the circuit board 60 may include a microcontroller 62, keypad circuit 64, LED circuit 66, Engine Run circuit 68, Engine Disrupt circuit 70, Door Open circuit 72, and audible alarm circuit 76.

The microcontroller 62 may be of any appropriate type or configuration, such that the microcontroller may be a small computer on a single integrated circuit including a processor core, memory, and programmable peripherals. Microcontrollers may be used in automatically controlled products and devices, such as automobile engine control systems and other embedded systems. With reference to FIG. 5, the microcontroller 62 may send out signals to operate a variety of the circuits 64, 66, 68, 70, 72. For example, as illustrated in FIG. 1, some of these circuits 68, 70, 72 may interact with components of the vehicle 12, such as the engine control module 14, engine 16, battery 18, and ignition 20 components.

The keypad circuit 64 may respond to the operator's commands via the buttons 50, 52, 54 to input a personal identification number (PIN) into the input device 30. The PIN may be a secret numeric password shared between an operator and a system, such as the electronic anti-theft system 10, which may be used to authenticate the operator to the system 10. The operator may continue to operate the vehicle 12 only when the PIN entered matches with the PIN stored in the system 10. The PIN may be of any appropriate amount of numeric digits, such as four, six, nine and the like. In an exemplary embodiment, the PIN may include four numeric digits. The LED circuit 66 may respond to certain buttons 50, 52, 54 being depressed in a predetermined order, such as during PIN entry, setting or re-setting of the PIN.

The Engine Run circuit 68 may respond to the correct PIN entry to keep the vehicle 12 running. Conversely, the Engine Disrupt circuit 70 may respond to an incorrect PIN entry or lack of any PIN being entered, whereby the engine 16 may be shut down.

The Door Open circuit 72 may respond to a correct PIN entry after the Engine Run circuit 68 has been activated and the door 22 has been opened. The circuit board 60 may also include a programmable header circuit 74. The programmable header circuit 74 may be utilized for downloading software onto the microcontroller 62. The audible alarm circuit 76 may send a signal to an audible alarm to instruct the alarm to begin emitting an audible sound.

The electronic anti-theft system 10 may include at least one timer (not shown). For example, the system 10 may include any appropriate number of timers to operate, such as a first timer (not shown) and a second timer (not shown). The dual timers may be integrally located within the components of the circuit board 60. For example, the dual timers may be located within the microcontroller 62. The microcontroller 62 may include and operate a dual or two stage timer (not shown). The first timer may be used for transmitting an electric first signal after a first predetermined period of time after being electrically activated by a key (not shown) to operate the vehicle 12. The second timer may be used for transmitting a second electric signal after a second predetermined period of time.

The first timer may be the initializing timer. The initializing timer may begin the up count to a specific timed set point once current flow is detected through the counter located on the circuit board 60. The amount of time may be a fixed set point for operator use, such as approximately thirty seconds. In an exemplary embodiment, the factory setting may be set at approximately thirty seconds, whereby the operator may have approximately thirty seconds to enter proper PIN before the Engine Disrupt circuit 70 may be activated and shut the engine 16 down. The first timer may be deactivated when the proper PIN is entered.

If the proper PIN is not entered within the set time period, the microcontroller 62 may send a signal output to begin the up counter on the second timer. The second timer may begin a timed sequence of any appropriate timeframe, such as approximately two to four minutes, and may also energize a control relay (not shown) that may be located on the circuit board 60. After the second timer counts down the approximate two to four minute timeframe, the second timer may send an output signal to reset the circuit board 60 back to the normal operation state and de-energize the control relay. This second timer sequence may begin again if the proper PIN is not entered within the predetermined amount of time after the engine 16 is started.

The input device 30 may serve as the operator interface for the PIN selection and the re-programming of a new PIN, as needed. Once programmed and entered correctly, the PIN may stop and reset the up counter of the first timer to zero, whereby the circuit board 60 will remain de-energized in the normal state of operation.

The power supply for the input device 30 may be the vehicles 12 twelve volt direct current (DC) power source for relay activation. The power may also supply a regulated 5 volt DC power source to the various components on the circuit board 60.

The battery 18 may be connected to the vehicle engine 16. While running, the engine 16 may emit engine noise and vibrations that may ride on the DC circuit. This engine noise and vibrations may indicate to the microcontroller 62 that the engine 16 is running and that a PIN code needs to be entered. For example, the Engine Run circuit 68 may operate when the proper PIN code has been entered into the input device 30 within the specified time allowed, whereby this may result in a reset signal stopping and re-setting the up count of the first timer, thereby allowing the external circuit to remain uninterrupted.

The Engine Disrupt circuit 70 may operate if the proper PIN code has not been entered into the input device 30 within the specified time, whereby the microcontroller 62 may break the external circuit continuity. The Engine Disrupt circuit 70 may shut the engine 16 down. For example, the Engine Disrupt circuit 70 may send a signal to the engine control module 14 of the vehicle system to remove power from the engine 16 and shut the engine 16 down. As an alternative, the pressure sensor located under the driver's side seat or the Door Open circuit 72 may trigger the first timer to begin the up counter to a predetermined set point.

In a non-limiting example, if an operator enters the vehicle 12 and starts the vehicle 12 with a duplicate key, but does not have the PIN, the engine 16 will shut down for approximately two to four minutes and the vehicle 12 will not start. After approximately two to four minutes the vehicle 12 will be able to restart.

The operator may operate the system 10 via the numeric digit buttons 54 (i.e., the 1 button, 2 button, 3 button and 4 button), two programming mode buttons (i.e., the ENTER button 50 and the CLEAR button 52) and the two LED indicating lamps (i.e., the Green LED 44 and the Amber LED 46). Also, the main circuit board 60 may respond to data inputs with corresponding flashes of the LED's to notify the user of data acceptance via the LED circuit 66.

The keypad circuit 64 and LED circuit 66 may respond to the operators input in setting the PIN. The Green LED 44 may be mounted at the top of the circuit board 60 and may flash a single pulse when data is entered for either normal PIN entry or re-programming a new PIN. The Amber LED 46 may be used to identify when the first timer has been activated with a one second flashing pulse. If the timer reaches the preset time allowed, then the Amber LED 46 may be lit up until the second timer is deactivated. The Amber LED 46 may be mounted directly next or adjacent to the Green LED 44. An additional LED (not shown) may also be included for backlighting the buttons 50, 52, 54 of the input device 30.

The input device 30 may come with a default PIN that may be factory set. For example, the PIN may be a 4-digit PIN. To set the PIN, the CLEAR button 52 may be depressed and held until the Amber LED 46 lights up. When the Amber LED 46 lights up, the CLEAR button 52 may then be released, whereby the Amber LED 46 will go out. After the Amber LED 46 light goes out, the ENTER button 50 may be depressed for a period of time until the Green LED 44 lights up. For example, the ENTER button 50 should be depressed within approximately two seconds after the CLEAR button 52 is released. Failure to depress the ENTER button 50 during the appropriate timeframe may abort the default PIN setting. After the Green LED 44 lights up, the ENTER button 50 may be released, whereby the Green LED 44 may go out. The default PIN is now set.

Each individual input device 30 may have a specific serial number and hard PIN code imbedded in the microcontrollers 62 ROM for master reset needs. This may act as a failsafe against operators forgetting their current PIN numbers. These serial numbers with encrypted PIN codes may be varied monthly along with daily security measures.

Each input device 30 produced may be pre-set to a factory master reset code for initial installation and operation, which may be entered into the microcontroller 62 RAM and may not affect the master PIN code already stored in the ROM location. This PIN may be changed by performing the following steps: (1) Hold down both CLEAR button 52 and ENTER button 50 for approximately three seconds until the Green LED 44 goes solid. (2) Enter the current PIN code followed by the ENTER button 50. This may ensure that the person re-programming the system is an authorized user. Once the correct PIN has been entered, the Green LED 44 may flash at one second interval awaiting the new code. (3) Enter the new PIN number followed by the ENTER button 50 and the Green LED 44 may go solid again for approximately three seconds before turning it off. Any wrong numbers entered during the programming may be corrected by depressing the CLEAR button 52 after the error has been entered.

The operator may change the PIN at any time. For example, the operator may desire to change his/her PIN in order to allow someone else to use his/her vehicle without comprising the PIN or simply to use a new PIN. Changing the PIN may be accomplished while the engine 16 is running and should be performed while the vehicle 12 is legally and safely parked. In order to change the PIN, both the CLEAR button 52 and ENTER button 50 should be depressed until the Green LED 44 lights up. After the Green LED 44 lights up, the CLEAR button 52 and ENTER button 50 may be released. Next, the current PIN code may be entered followed by depressing the ENTER button 50.

After the current PIN has been entered, the Green LED 44 may flash, whereby a new PIN code may be entered followed by depressing the ENTER button 50. The Green LED 44 may stop flashing and remain on for a predetermined amount of time, such as approximately three seconds, and then go off. If the operator depresses or inputs a wrong number, he/she may depress the CLEAR button 52 and then depress the correct number.

In a non-limiting example, when power is first applied, the system 10 may be disabled for any predetermined amount of time, such as approximately ten seconds. After this ten second period, the Green LED 44 and Amber LED 46 may illuminate for a predetermined amount of time, such as approximately two seconds. After this two second period, the Green LED 44 and Amber LED 46 may go out, at which time the system 10 may be fully operational.

After the engine 16 of the vehicle 12 is started, the operator may have approximately thirty seconds to enter the 4-digit PIN followed by depressing the ENTER button 50. This approximate thirty second period of time may be indicated by the flashing of the Amber LED 46. The audible alarm circuit 76 may send a signal to an audible alarm to instruct the alarm to begin emitting an audible sound approximately ten seconds before the Amber LED 46 stops flashing. For example, the audible alarm 76 may beep for approximately the last ten seconds that the Amber LED 46 flashes.

Failure to enter the correct 4-digit PIN followed by depressing the ENTER button 50 within approximately thirty seconds may cause the engine 16 to shut down. In addition, the engine 16 may not start for an additional predetermined period of time, such as an approximately two minute or four minute period. This two to four minute period of time may be selectable via the switch 58 on the side of the input device 30.

If the correct 4-digit PIN is entered and followed by the operator depressing the ENTER button 50 within approximately thirty seconds, the engine 16 may operate as normal until it is turned off by the operator. As each PIN digit is depressed, the Green LED 44 may flash or temporarily light up to acknowledge that the respective numeric digit button 54 is being depressed. If the correct PIN has been entered, the Amber LED 46 may stop flashing and the Green LED 44 may light up for approximately three-quarters of a second after the ENTER button 50 is released.

In normal operation, the system 10 may begin counting on power up sensed through current output from the microcontroller 62 to the first timer. The operator may then enter the proper PIN code followed by depressing the ENTER button 50. Entry of the proper PIN may de-activate the Engine Disrupt circuit 70 and may permit normal mode of operation via the Engine Run circuit 68.

After failure to enter the correct PIN or failure to enter any PIN, the vehicle 12 may operate for a predetermined period of time. The objective of the time delay may be to cause the vehicle 12 to stall at a position remotely located from the point at which it was stolen. The time delay mechanism may permit the vehicle 12 to be started and driven from where it was stolen, only to later stall at some other location. The thief may abandon their plan to steal the vehicle 12 and look elsewhere. Once the vehicle 12 is disabled, and after waiting the predetermined period of time, such as two or four minutes, the engine 16 may be enabled by a specific combination of operator actions to allow the vehicle 12 to operate.

The system 10 may have the flexibility to disable the vehicle 12 upon the automatic sensing of the opening of the driver's door 22, such as while the engine 16 is running or upon a signal, such as a Door Open circuit 72, transmitted by the system 10. Under certain circumstances, when the door 22 is opened, a disablement sequence may start for disabling the engine 16 of the vehicle 12. With reference to FIG. 1, the system 10 may interact with a courtesy light or door sensor 24.

As illustrated in FIG. 1, the door sensor 24 may be attached to the inside of the driver's side door 22. The door sensor 24 may sense the opening of the door 22. For example, when the door 22 opens, the door sensor 24 may output an opened door signal to the microcontroller 62. For example, the door sensor 24 may be a wire connected to the vehicle's 12 existing pin switch (not shown). Most vehicles 12 may already include a pin switch for completing a circuit to illuminate a dome light.

The electronic anti-theft system 10 may include a Door Open circuit 72. The Door Open circuit 72 may operate when the driver side door 22 is opened after starting the vehicle 12 and initially entering the PIN. If the driver side door 22 is opened while the engine 16 is running, the PIN must be entered within a predetermined amount of time, such as approximately thirty seconds, in order to prevent the engine 16 from shutting down. During this timeframe, the Amber LED 46 may be flashing. In addition, the audible alarm circuit 76 may send a signal to the audible alarm to instruct the alarm to begin emitting an audible sound approximately ten seconds before the Amber LED 46 stops flashing. For example, the audible alarm 76 may beep for approximately the last ten seconds that the Amber LED 46 flashes.

This Door Open circuit 72 may act as an anti-carjacking feature. If the operator knows that he/she is going to leave the vehicle 12 after starting the engine 16, the operator may temporarily disable this Door Open circuit 72 for one “Engine Run” cycle. This “carjack override” feature may work for one Engine Run cycle. Once the engine has been turned off, this temporary override may re-set itself to normal operation. Deactivating the Door Open circuit 72 may be accomplished by following a disablement sequence. The operator may re-entering the correct 4-digit PIN prior to opening the door 22. Re-entering the PIN may allow the operator to leave his/her vehicle 12 while it is running, whereby the engine 16 may not shut down. It is not recommended that any operator leave his/her vehicle 12 unattended with the engine 16 running, as doing so may unsafe as well as illegal in some cities and/or states.

When the system 10 is in an override situation, the door 22 may be opened while the engine 16 is running without having to initiate the disablement sequence. This may permit the operator to exit the vehicle 12 and to allow the vehicle 12 to be left running, such as when the operator may clean the windshield or warm up the vehicle in cooler temperatures.

In a non-limiting example, the operator may be stopped at a traffic light. While waiting for the traffic light to change, a carjacker may appear at the window and point a gun at the operator demanding that the operator give over the vehicle 12. To end the confrontation, the operator may easily comply with the carjacker's demands knowing that the vehicle 12 may not get any more than approximately thirty seconds away.

Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of the claims hereafter.

Having thus described the invention, the following is claimed:

1. An electronic anti-theft system comprising:
an input device adapted to communicate with an engine control module of a motor vehicle, wherein the engine control module is capable of controlling an engine of the motor vehicle;
a microcontroller located within the input device, wherein the microcontroller is adapted to communicate with the engine control module;
the microcontroller adapted to communicate with a door sensor of the vehicle, wherein the microcontroller is capable of detecting when a door is opened;
the microcontroller includes a door open circuit capable of sending a signal to the engine control module to disable the engine after a predetermined amount of time has lapsed in response to detecting that the door was opened; and
wherein the microcontroller is operative to disable the engine provided that a predetermined input is not received at the input device within the predetermined amount of time.

2. The system of claim 1, wherein the predetermined input is a personal identification number.

3. The system of claim 1, wherein the predetermined amount of time is approximately thirty seconds.

4. The system of claim 1, wherein the input device is adaptive to being removably secured to an interior of a motor vehicle.

5. The system of claim 1, wherein the input device includes a plurality of buttons.

6. The system of claim 1, wherein the input device includes at least one visual indicator.

7. The system of claim 7, wherein the at least one visual indicator is a light emitting diode.

8. The system of claim 1, wherein the input device includes an audible alarm.

9. The system of claim 1, wherein the microcontroller is operative to permit the engine to run provided that the predetermined input is received at the input device within the predetermined amount of time.

10. A method of operating an electronic anti-theft system comprising the steps of:
engaging an input device with an engine control module of a motor vehicle, wherein the input device includes a microcontroller capable of detecting when an engine of the motor vehicle has been started;
receiving a predetermined input into the input device within a predetermined amount of time, thereby activating an engine run circuit;
detecting the opening of a driver's side door after receiving the predetermined input, thereby activating a door open circuit;
failing to receive the re-entry of the predetermined input within the predetermined amount of time, thereby activating an engine disrupt circuit; and
disabling the engine for a specified amount of time by way of the engine disrupt circuit.

11. The method of claim 10, wherein the predetermined input is a PIN.

12. The method of claim 11 further comprising the step of re-enabling the engine by entering the PIN into the input device after the specified amount of time.

13. The method of claim 10, wherein the predetermined amount of time is approximately thirty seconds.

14. The method of claim 10, wherein the specified amount of time is about two minutes to about four minutes.

15. The method of claim 10 further comprising the step of activating an audible alarm circuit prior to an end of the predetermined amount of time.

16. The method of claim 15, wherein the audible alarm circuit activates an alarm to beep for approximately ten seconds.

17. The method of claim 10, wherein the door open circuit is capable of being disabled for one engine run cycle.

18. The method of claim 16, wherein the door open circuit is temporarily disabled by re-entering the predetermined input prior to opening the door, whereby the engine will not be disabled.

19. The method of claim 10, wherein the microcontroller is adapted to be responsive to the PIN received by the input device.
